(19) United States
(12) Patent Application Publication
(10) Pub. No.: US 2023/0100222 A1
(43) Pub. Date: Mar. 30, 2023

(54) AUTOMATED APPARATUS AND METHOD FOR OBJECT FACETING

(71) Applicant: Zalirian Ltd., Ramat-Gan (IL)

(72) Inventors: Oded BEN SHMUEL, Petach-Tikva (IL); Shilo STOPER, Kfar Saba (IL); Omri SPIRMAN, Even Yehuda (IL)

(73) Assignee: Zalirian Ltd., Ramat-Gan (IL)

(21) Appl. No.: 17/910,839

(22) PCT Filed: Mar. 11, 2021
(86) PCT No.: PCT/IL2021/050272

§ 371 Date: Sep. 12, 2022

Related U.S. Application Data
(60) Provisional application No. 62/987,875, filed on Mar. 11, 2020.

(51) Int. Cl. A44C 17/00; B24B 49/14; B24B 27/00; B25J 11/00

(52) U.S. Cl. CPC A44C 17/001; B24B 49/14; B24B 27/0069; B25J 11/0065

(57) ABSTRACT

An apparatus for automated polishing of an object with multiple facets includes a polishing wheel, a robotic arm, a sensor and a controller. The robotic arm positions the object in contact with the polishing wheel. The sensor senses a polishing related parameter during polishing of the object with the polishing wheel. The controller operates the robotic arm to rotate the object about an axis perpendicular to the polishing wheel, receives a sensing signal from said sensor at different orientations of said object during polishing and selects a polishing orientation from the different orientations based on said sensing signal.

### RELATED APPLICATION

This application claims the benefit of priority of U.S. Provisional Patent Application No. 62/987,875 filed on Mar. 11, 2020, the contents of which are incorporated herein by reference in their entirety.

### FIELD AND BACKGROUND OF THE INVENTION

The present invention, in some embodiments thereof, relates to automated apparatuses and methods for object faceting and, more particularly, but not exclusively, to an automated apparatus and method for faceting diamonds.

Traditionally, faceting objects such diamonds and other gems have been performed manually with a polishing wheel, e.g. a scaif. This manual process is known to be time consuming and expensive. Computer methods are known for assisting in planning the polishing of a rough gem. Often a three-dimensional (3D) model of the rough gem is generated and a target polished gem may be defined within the three-dimensional model. However, after the plan is in place, the subsequent polishing process, by which each facet of the gem is cut and polished, is typically performed manually so that the process may be monitored and adjustments may be made as needed.

The faceting process may introduce artifacts on a surface of the gem such as pits, scratches and polishing lines. In addition, natural artifacts within the gem may surface during the polishing process. Human intervention is typically required to adapt the faceting process to overcome these obstacles. Inaccuracies in the polishing process itself may also require human intervention. High temperatures may arise due to the friction between the gem and the polishing wheel and may affect precision of the polishing. When polishing a diamond, certain polishing directions may be more resistant to polishing as compared to others due to the crystal structure of the diamond. Polishing in an unfavorable polishing direction hinders the ability to polish and may affect the polish finish. Repetitive monitoring and adjusting is required to obtain a high quality final product. For an automated process to replace the traditional manual polishing method, high precision faceting with the ability to adapt the faceting process over the course of the process would be required.

International Patent Application Publication No. WO/2019/042850 entitled “Improved methods for controlling the polishing of gemstones,” the contents of which is incorporated herein by reference discloses a method for controlling the polishing of a gemstone. The method includes obtaining a three-dimensional model of the gemstone; fixing the gemstone in a dop, wherein an initial facet to be polished is aligned; obtaining at least one image of the initial facet while the gemstone is in the tang such that a contour of the initial facet can be determined from the at least one image. Based on the obtained at least one image and the obtained three-dimensional model, at least first setting parameters for a first planned facet positioned between the initial facet and a desired final polished facet is determined. The dop for obtaining a polished gemstone having a polished facet approaching the first planned facet is set. At least one image of the polished while the gemstone is in the tang is obtained. Based on the obtained at least one image of the polished facet and the three-dimensional model, determining at least further setting parameters for a further planned facet. Setting the dop for obtaining a polished gemstone having a polished facet approaching the further planned facet.

International Patent Application Publication No. WO/2019/043488 entitled “An automatic gemstone polishing robot,” the contents of which is incorporated herein by reference describes a fully automatic gemstone polishing robot. The automatic gemstone polishing robot includes a gemstone polishing unit, an image capturing unit and an image processing unit. The imaging processing unit is executed by one or more processors and analyzes images of the gemstone with respect to one or a plurality of gemstone parameters. The image processing unit compares the one or a plurality of analyzed gemstone parameters with one or a plurality of pre-determined gemstone parameters to generate the feedback signal to be transmitted to the gemstone polishing unit. The gemstone polishing unit includes a gemstone holding unit for supporting a gemstone in contact with an abrasive surface and polishes the gemstone in a plurality of iterations based on a feedback signal.

### SUMMARY OF THE INVENTION

According to an aspect of some example embodiments there is provided an automated apparatus and method for faceting an object in a fully automated process with improved precision and/or control. In some example embodiments, the automated apparatus and method is additionally configured for reducing the time it takes to facet an object. In some example embodiments, the automated apparatus and method is configured to detect favorable polishing directions. In some example embodiments, the automated apparatus and method is configured to provide an authentication trail for identifying the object over the entire faceting procedure. In some example embodiments, the apparatus and method provides generating an automated signature key for a faceted object.

According to an aspect of some example embodiments, there is provided an apparatus for automated faceting of an object, comprising: a polishing wheel; a robotic arm configured to position the object in contact with the polishing wheel; a sensor configured to sense a polishing related parameter during polishing of the object by the polishing wheel; and a controller configured to: operate the robotic arm to rotate the object about an axis perpendicular to the polishing wheel; receive a sensing signal from the sensor at different orientations of the object during polishing; and select a polishing orientation from the different orientations based on the sensing signal.

Optionally, the controller is configured to rotate the object while maintaining contact between the object and the polishing wheel and to continuously receive the sensing signal during the rotation.

Optionally, the polishing orientation selected by the controller is an orientation at which the polishing related parameter has a predefined recognizable feature.

Optionally, the sensor is configured to sense an amplitude or frequency of vibration associated with the contact of the object with the polishing wheel during polishing and wherein the polishing orientation selected is an orientation at which the amplitude or frequency of vibration exhibits a predefined recognizable feature.

Optionally, the sensor is selected from a group including: a microphone, a displacement sensor and an accelerometer.

Optionally, the sensor is a temperature sensor configured to sense heat dissipated during polishing based on the contact of the object with the polishing wheel and wherein the polishing orientation selected is an orientation at which the temperature exhibits a predefined recognizable feature.

Optionally, the apparatus includes at least one additional sensor configured to sense an additional polishing related parameter during polishing and wherein the controller is configured to select the polishing orientation based on the sensing signal from the sensor and an additional sensing signal from the additional sensor.

Optionally, the controller is configured to repeat the operating, the receiving, and the selecting for each of a plurality of facets on the object.

Optionally, the apparatus includes an imaging system, wherein the controller is configured to operate the robotic arm to maneuver the object to a focal plane of the imaging system, and to operate the imaging system to image a facet of the object intermittently with the polishing.

Optionally, the controller is configured to automatically operate the robotic arm to alter the polishing orientation based on the image data from the imaging system.

According to an aspect of some example embodiments, there is provided a method for automated faceting of an object, the method comprising: positioning the object in contact with a polishing wheel; rotating the object about an axis perpendicular to the polishing wheel with a robotic arm; receiving a sensing signal from a sensor at different orientations of the object during polishing, wherein the sensor is configured to sense a polishing related parameter; and selecting a polishing orientation from the different orientations based on the sensing signal.

Optionally, the method includes maintaining contact between the object and the polishing wheel while rotating the object and receiving a continuum of the sensing signal during the rotation.

Optionally, the polishing orientation selected is an orientation at which the polishing related parameter has a predefined recognizable feature.

Optionally, the sensor is configured to sense vibration, sound, displacement, heat dissipated or current supplied to the robotic arm during polishing during the contact of the object with the polishing wheel.

Optionally, the method includes sensing at least one additional polishing related parameter during polishing and selecting the polishing orientation based on the polishing related parameter and the additional polishing related parameter.

Optionally, repeating the positioning, the rotating, the receiving and the selecting for each of a plurality of facets on the object.

Optionally, imaging a facet of the object intermittently with the polishing, wherein the imaging is performed while the object is mounted on the robotic arm.

Optionally, the method includes altering the polishing orientation based on the image data from the imaging system.

According to an aspect of some example embodiments, there is provided a method for automated faceting of an object, the method comprising: polishing the object with a polishing wheel concurrently with: sensing at least one polishing related parameter; and in a closed loop control, adjusting at least one operation parameter selected from the group consisting of: rotation speed of the polishing wheel, contact pressure of object against polishing wheel and track position of the object on the rotating wheel, responsively to a value of the sensed polishing related parameter.

Optionally, the adjusting is selected to control a material removal rate for removing material from the object.

Optionally, the method includes terminating the polishing when a value of the parameter is within a predetermined range.

According to an aspect of some example embodiments, there is provided an apparatus for automated faceting of an object comprising: a polishing wheel; a robotic arm configured to position the object in contact with the polishing wheel; a sensor configured to sense at least one polishing related parameter during polishing of the object by the polishing wheel; and a controller configured to adjust at least one operation parameter selected from the group consisting of current to the robotic arm, a rotation speed of the polishing wheel, and track used on the polishing wheel, during the polishing and in a closed loop control, responsively to a value of the sensed polishing related parameter.

Optionally, there are at least two polishing related parameters, and wherein one of the at least two polishing related parameters is a vertical position of the object.

Optionally, the at least one polishing related parameter is selected from the group consisting of: vibration, sound, displacement, dissipated heat and pressure applied on the object, associated with contact of the object with the polishing wheel during polishing.

Optionally, the at least one polishing related parameter is electrical current supplied to the robotic arm, the electrical current related to pressure of the object against polishing wheel.

Optionally, the method includes accessing a computer readable medium storing a lookup table having a plurality of entries, each comprising a value of the polishing related parameter and associated at least one operation parameter, searching the lookup table for an entry corresponding to the sensed polishing related parameter; and setting the at least one operation parameter according to a respective value in the entry.

According to an aspect of some example embodiments, there is provided a method for automated faceting of an object, the method comprising: operating a robotic arm to rotate the object about an axis perpendicular to a polishing wheel during polishing of a first facet of the object the; sensing a polishing related parameter during the polishing; identifying one to four orientations of the robotic arm at which the polishing related parameter has a predefined recognizable feature, thereby identifying respective one to four candidate orientations for polishing; repeating the operating, the sensing, and the identifying for one or more additional facets of the object until at least four candidate orientations for polishing are identified; and using the at least four candidate orientations for selecting a polishing orientation for an additional facet of the object.

Optionally, the method includes predicting crystallographic axes of the object based on the at least four candidate polishing directions.

Optionally, the method includes defining an orthogonal projection of at least one of the crystallographic axes on the additional facet of the object based on the prediction.

Optionally, the method includes updating the prediction of the crystallographic axes based on sensing the polishing related parameter while polishing at least one facet of the object other than the one or more additional facets.

Optionally, the method includes imaging at least one facet of the objects between intervals of polishing, and updating prediction of the crystallographic axes based on image data from the imaging.

According to an aspect of some example embodiments, there is provided an apparatus for automated faceting of an object comprising: a laser cutting device configured for cutting the object; a polishing wheel configured for polishing the object; a robotic arm configured to hold the object; and a controller configured to operate the robotic arm to position the object with respect to the laser cutting device for removal of a first portion of the object by laser cutting, and subsequently to operate the robotic arm to position the object with respect to the polishing wheel for removal of a second portion of the object by polishing without disengaging the object from the robotic arm, wherein the first portion and the second portion is selected to reduce a duration required for polishing the object.

Optionally, the apparatus includes a processor; and an imaging system configured to capture images of the object mounted on the robotic arm, wherein the controller is configured to operate the robotic arm to position the object with respect to the imaging system and wherein the processor is configured to build a three dimensional model of the object held on the robotic arm based on the images and to define the boundaries of the first portion and the second portion based on the three dimensional model.

Optionally, an amount of material included in the first portion greater than that of the second portion.

According to an aspect of some example embodiments, there is provided a method for automated faceting of an object, the method comprising: operating a robotic arm on which the object is mounted to position the object with respect to a laser cutting device for removal of a first portion of the object by laser cutting; and subsequently and without disengaging the object from the robotic arm, operating the robotic arm to position the object with respect to a polishing wheel for removal of a second portion of the object by polishing, wherein the first portion is larger in volume than the second portion.

Optionally, the method includes operating the robotic arm to position the object with respect to an imaging system configured for defining a three-dimensional model of the object, and defining boundaries of the first portion and the second portion based the three-dimensional model, wherein the defining is performed prior to the laser cutting and the polishing; and maintaining the object on the robotic arm after the imaging and over the duration of the polishing and the laser cutting.

According to an aspect of some example embodiments, there is provided an apparatus for automated faceting of an object, comprising: a polishing wheel; a press-pot marked with an identity code and configured to hold the object, wherein the identity code identifies the object; a robotic arm configured to hold the press-pot and to position the object in contact with the polishing wheel during polishing; an identity code reader configured to read the identity code while the robotic arm is holding the press-pot; and a controller configured to access instructions on a computer readable medium for polishing the object based on identifying the identity code on the press-pot and to control operation of the apparatus for polishing the object based on the instructions.

Optionally, the apparatus includes an imaging system configured for capturing images of the object on the robotic arm and to define a three-dimensional model of the object based on the images and wherein the identity code reader is integrated with the imaging system.

Optionally, the press-pot comprises: a clasp section configured for holding the object;

a base section configured to be mounted on a robotic arm for holding the press-pot with the object clasped therein; a middle section extending from the base section to the clasp section, wherein the middle section includes a plurality of holes formed thereon; and a plurality of plugs configured to be selectively fitted into one or more of the plurality of holes wherein the selectively fitted plugs define the identification code.

According to an aspect of some example embodiments, there is provided a method for automated faceting of an object, comprising: mounting the object on a press-pot, wherein the press-pot includes an identity code configured to identify the object; operating a robotic arm to position the press-pot with the object toward a reader configured to read the identity code; accessing instructions for polishing the object on a computer readable medium based on the identity code; and operating the robotic arm and a polishing wheel during polishing to polish the object based on the instructions.

Optionally, the reader is integrated into an imaging system configured for capturing images of the object on the robotic arm and for defining a three-dimensional model of the object based on the images.

According to an aspect of some example embodiments, there is provided a method for defining a gem signature key for a polished gem, the method comprising: determining geometry, three dimensional position, and morphology of each of a plurality of facets of the gem with an imaging system of an automated polishing apparatus; generating a signature key for the gem based on the geometry, the three dimensional position and the morphology; and storing the key in a computer readable medium.

According to an aspect of some example embodiments, there is provided a method for faceting of an object, comprising: obtaining a three-dimensional model of the object and a target three-dimensional shape having a plurality of facets; for each of a plurality of facets of the target shape, calculating based on the model an amount of material to be removed from the object to form the facet; generating an ordered list of the plurality of facets in a manner that the calculated amounts are descending within the list; and executing a protocol for polishing the plurality of facets of the object according to the ordered list.

According to an aspect of some example embodiments, there is provided a method for faceting an object, comprising: obtaining a three-dimensional model of the object, and a target three-dimensional shape defining the multiple facets; for each of a plurality of facets of the target shape, calculating based on the model a projection of a crystallographic axis of the object onto the facet; generating an ordered list of the plurality of facets in a manner that the calculated magnitude of the projections are descending within the list; and executing a protocol for polishing the plurality of facets according to the ordered list.

According to an aspect of some example embodiments, there is provided a method for faceting an object, comprising: obtaining a three-dimensional model of the object, and a target three-dimensional shape defining the multiple facets; for each of a plurality of facets of the target shape, calculating based on the model a projection of a crystallographic axis of the object onto the facet, an amount of material to be removed from the object to form the facet, and a fabrication score which is a weighted combination of the projection and the amount of material removed; generating an ordered list of the plurality of facets in a manner that the calculated scores are descending within the list; and executing a protocol for forming the plurality of facets according to the ordered list.

Optionally, the method includes forming at least two facets of the object with an automated polishing apparatus; sensing a polishing related parameter during the forming; and predicting crystallographic axes of the object based on the sensing; wherein the generating the ordered list of the plurality of facets is also based on the prediction.

Optionally, the method includes imaging the object intermittently with the forming to determine geometry and morphology of a facet being formed, and updating the ordered list based on the imaging.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified schematic drawing of an automated faceting apparatus in accordance with some example embodiments;

FIG. 2 is a simplified schematic drawing of an example imaging system for the automated faceting apparatus, in accordance with some example embodiments;

FIG. 3 is a simplified flow chart of an example method to generate a 3D model of an object for faceting, in accordance with some example embodiments;

FIGS. 4A, 4B and 4C are simplified drawings depicting three example sets of instructions for forming a same plurality of facets on an object, all in accordance with some example embodiments;

FIG. 5 is a simplified flow chart of an example method to generate an ordered list for forming facets on an object whose chemical structure is a crystal lattice, in accordance with some example embodiments

FIG. 6 is a simplified flow chart of an example method to select an orientation of a facet on a polishing wheel during polishing, in accordance with some example embodiments;

FIGS. 7A and 7B are example graphs showing output from sensors sensing a polish related parameter while an object is rotated about an axis perpendicular to a polishing wheel during polishing, in accordance with some example embodiments;

FIGS. 8A and 8B are simplified drawings showing example crystallographic axes in relation to a facet of an object in accordance with some example embodiments;

FIG. 9 is a simplified flow chart of an example method to predict crystallographic axes of the object in accordance with some example embodiments;

FIG. 10 is a simplified flow chart of an example method to adjust a polishing on-the-fly with the automated polishing apparatus, in accordance with some example embodiments;

FIG. 11 is a simplified flow chart of an example method to adjust the polishing based on image data captured with the automated polishing apparatus, in accordance with some example embodiments;

FIG. 12 is a simplified schematic drawing of a modeled geometry for an example modeled facet and two example discrepancies in facet geometry that may occur during faceting in accordance with some example embodiments;

FIG. 13 is a simplified flow chart of an example method to detect and record parameters of the object at the end of the faceting process;

FIG. 14A is a simplified schematic drawing of an example automated faceting apparatus including both a laser cutting station and a polishing station, in accordance with some example embodiments;

FIG. 14B is a simplified schematic drawing of a laser cutting station of in accordance with some example embodiments;

FIG. 15 is a simplified flow chart of an example method to combine laser cutting and polishing to facet an object in accordance with some example embodiments;

FIG. 16 is an example press-pot for holding an object in accordance with some example embodiments; and

FIG. 17 is a simplified flow chart of an example method to identify object with press-pot identification code, in accordance with some example embodiments.

### DESCRIPTION OF SPECIFIC EMBODIMENTS OF THE INVENTION

The present invention, in some embodiments thereof, relates to automated apparatuses and methods for polishing multi-faceted objects and, more particularly, but not exclusively, to an automated apparatus and method for polishing diamonds.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

According to some example embodiments, the apparatus and method provides an automated method for detecting favorable polishing directions. A favorable polishing direction for a facet may be detected based on sensing one or more polishing related parameter over different orientations of the facet on the polishing wheel. Optionally and preferably, the polishing related parameter provide indication of a rate of material removed and the favorable polishing direction is a direction with a relative high rate and/or a peak rate of material removed.

In some example embodiments, the apparatus and method provides adjusting operational parameters on-the-fly during polishing with closed loop control. In some example embodiments, the closed loop control is configured to maintain a steady, controlled and/or constant rate of material removed on a facet as the depth of polishing and surface area of the facet increases. Optionally, rotation speed of said polishing wheel, contact pressure of object against polishing wheel and/or track position of the object on the rotating wheel is controlled on-the-fly.

According to some example embodiments, the object's chemical structure is a crystal lattice and the apparatus and method is configured to predict the crystallographic axes of the crystal based on a trial-and-error process performed on one or more facets of the object. In some example embodiments, the crystallographic axes are extrapolated based on at least four favorable polishing directions sensed through a trial-and-error process. According to some example embodiments, one of the orthogonal projections of the crystallographic axes on a facet is selected as a favorable polishing direction for that facet.

According to some example embodiments, the apparatus includes both laser cutting and polishing capability and a controller configured to operate the robotic arm to position the object with respect to said laser cutting device for removal of a first portion of the object by laser cutting, and subsequently to operate said robotic arm to position the object with respect to said polishing wheel for removal of a second portion of the object by polishing without disengaging the object from said robotic arm. Optionally, integrating laser cutting into the faceting process may significantly reduce the processing time required for faceting.

According to some example embodiments, the apparatus and method is configured to maintain an authentication trail identifying the object throughout the faceting process based on a series of images captured over the faceting process. The authentication trail preferably comprises sufficient information to identify the raw, pre-polished object, both during the polishing process, and after the polishing process is completed. The authentication trail can be in the form of, for example, a library of descriptors that is associated with the object, once polished, and that describes the polishing process, optionally and preferably by its entirety. The descriptors may be in the form of digital images and/or computer rendered shapes and/or computer rendered coordinates. In some embodiments of the present invention the library includes a set of descriptors for each facet formed by the apparatus, wherein each set of descriptors is time-ordered and describes the evolution of the shape of the respective facet during its formation by the apparatus.

In some example embodiments, a press-pot holding the object includes an identity (ID) code and a controller is configured to access instructions on a computer readable medium for polishing the object based on identifying the identity code on the press-pot.

According to some example embodiments, the apparatus and method is configured to compute an ordered list based on which the object is faceted. In some example embodiments, the ordered list is defined to reduce the processing time required for faceting. Optionally, the processing time may be reduced based on reducing joint movement of the robotic arm over the faceting process. Optionally, a plurality of parameters are considered when determining the order for polishing. Non-limiting examples of these parameters include volume of material to be removed, crystallographic orientation relative to the facet to be polished and location of artifacts detected in or on the surface of the object.

According to some example embodiments, the apparatus and method is configured to generate a signature key for a polished object based on a geometry of each of its facets, a 3D position of each of its facets and a morphology of the facets. Unlike the authentication trail that links the raw object to the polished object by recording steps of the polishing process, and therefore authenticates that the polished object originates from the raw object, the signature key describes only the shape and morphology of the polished object. In some embodiments of the present invention the signature key also includes a grade (e.g., a cut grade, polish grade, symmetry grade) of the object. Optionally, a grade of the object is separately generated.

According to some example embodiments, the apparatus includes an inspection station with an imaging system and an image processor. According to some example embodiments, the imaging system comprises a telecentric imaging system and a microscope imaging system, and the image processor comprises a circuit configured to process the captured images from both the telecentric imaging system and a microscope imaging system, generate a 3D model of the object and optionally and preferably also inspect facets of the object over the course of the automated faceting process. According to some example embodiments, the 3D model is generated with the telecentric imaging system based on shadow modeling and optionally refined based on selected images captured with microscope imaging system. Optionally and preferably, the image processor is also configured to classify artifacts detected on a surface of a facet(s). Optionally and preferably, the 3D model is generated while the object is mounted on the robotic arm so that the generated model is defined with the coordinate system of the apparatus. In some example embodiments, when a 3D model of the object and/or a target model of the object defining the faceting plan is received together with the object, registration is performed between the 3D model generated and the model(s) received. Optionally and preferably, registration is performed at the imaging station at the onset of the automated process.

In some example embodiments, during the automated faceting process, the robotic arm is configured to move the object to the inspection station between polishing iterations for inspecting a formed facet and optionally and preferably updating the generated 3D model of the object. According to some example embodiments, at the end of the automated faceting process, the robotic arm moves the object to the inspection station again for a final inspection of the object. In some example embodiments, the final inspection includes defining a grade (e.g., a cut grade, a polish grade, a symmetry grade) of the object based on image data captured with the imaging system. In some example embodiments, the final inspection includes generating the signature key based on image data captured with the imaging system. Optionally and preferably, but not necessarily, the signature key uniquely identifies the object.

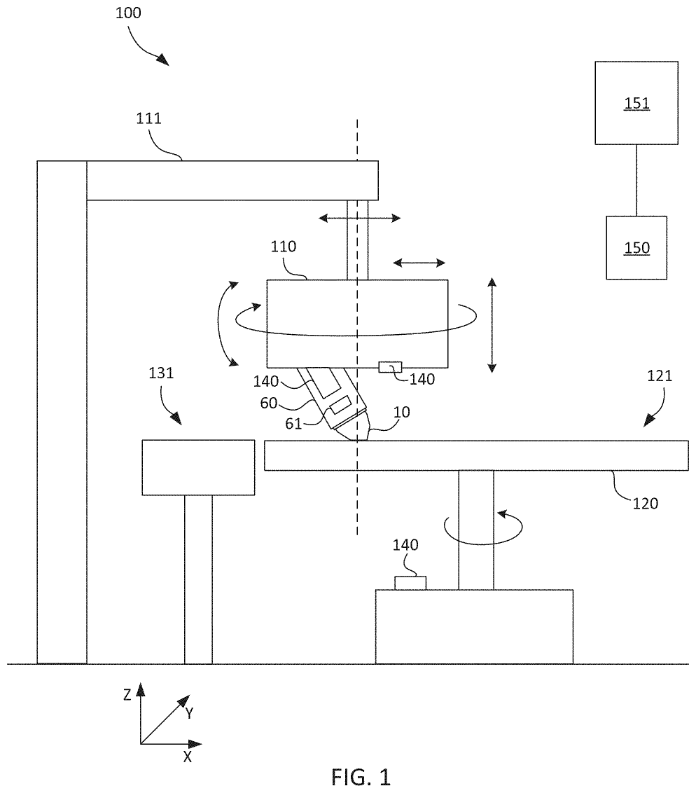

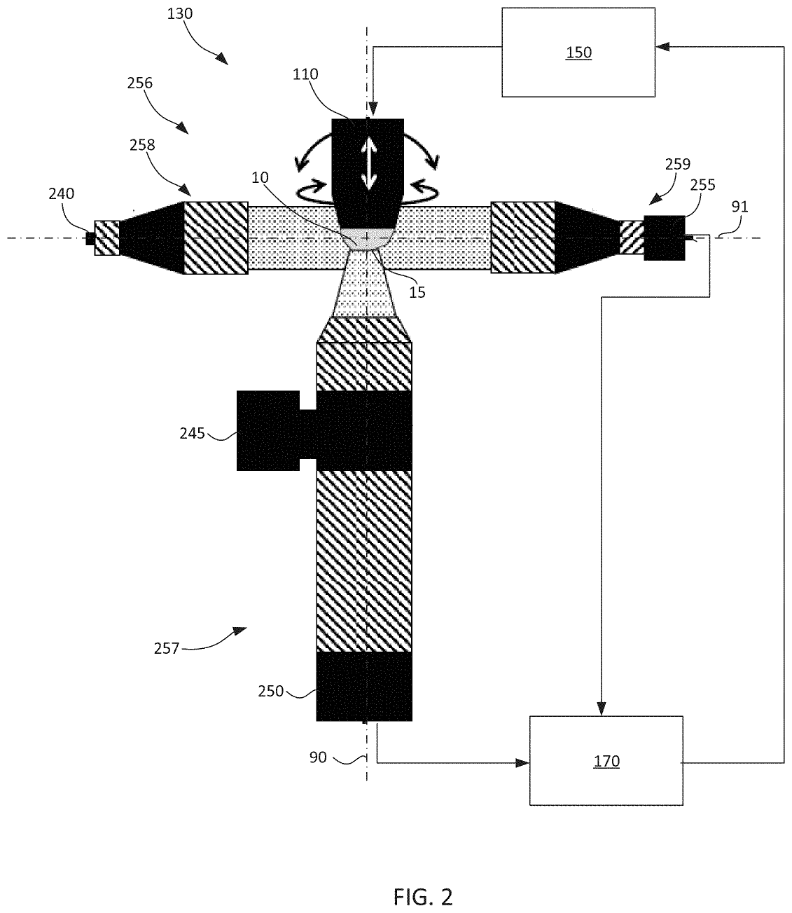

FIG. 1 is a simplified schematic drawing of an automated faceting apparatus 100 in accordance with some example embodiments. Automated faceting apparatus 100 comprises a robotic arm 110 configured to hold an object 10 during faceting, and a polishing station 121 including polishing wheel 120 for polishing object 10. Optionally, apparatus 100 comprises an imaging station 131 including an imaging system with image processing capability for inspecting object 10. An example imaging system is shown in FIG. 2. In some embodiments of the present invention apparatus 100 comprises one or more sensors 140 for sensing polishing related parameters. A controller 150 is optionally and preferably configured for controlling arm 110 to move object 10 between polishing station 121 and imaging station 131, and optionally and preferably also for controlling operation of apparatus 100 based on output from sensors 140 acquired while polishing and/or based on image data acquired at imaging station 131. Controller 150 may be configured to coordinate operation of robotic arm 110 with each of polishing station 121 and imaging station 131 as well as sensors 140. Controller 150 is preferably a computerized controller and may include processing and memory capability and may also communicate with a computing device 151 including processing capability, memory and user interface capability. In some embodiments of the present invention controller 150 comprises a dedicated electronic circuit configured for executing one or more of the operations described herein.

Robotic arm 110 may provide movement with multiple degrees of freedom, e.g. 4-6 degrees of freedom. In some example embodiments, robotic arm 110 is configured for both gross movement capability and fine movement capability in one or more directions. Gross movement capability is useful for moving object 10, for example, between polishing station 121 and imaging station 131. Fine movement capability is useful, for example, for orienting object during polishing and inspection with high resolution, e.g., sub-micrometer resolution (for example, resolution of 0.01-0.9 μm) for linear movements and milli-degree resolution (for example, resolution of 0.01·10⁻³−0.9·10⁻³ degrees) for rotational movements. Optionally and preferably, robotic arm 110 is mounted on a rail 111 and is actuated to shift between polishing station 121 and imaging station 131 along rail 111. Object 10 is optionally and preferably mounted on robotic arm 110 with a press-pot 60. In some example embodiments, press-pot 60 is marked with an identification (ID) code 61 to identify object 10. Representative examples of ID code suitable for exemplary embodiments of the present invention are provided below.

Sensors 140 may be mounted on robotic arm 110, and/or on press-pot 60, and/or polishing wheel 120. One or more of sensors 140 may sense remotely, instead of being mounted on any of robotic arm 110, press-pot 60, and polishing wheel 120. Sensors 140 may include for example one or more vibration sensors, e.g. accelerometer, microphone, temperature sensors, and displacement sensors. Displacement may be sensed with an encoder, e.g. a displacement encoder configured to sense the height of object 10 along the Z axis during polishing. Optionally, displacement is also sensed in the X direction and/or Y direction with dedicated encoders. In some example embodiments, sensors 140 include one or more sensors configured to sense electrical current supplied to robotic arm 110 and/or polishing wheel 120. The electrical current is indicative of friction generated between object 10 and polishing wheel 120 during polishing and also of the pressure applied against polishing wheel 120 with object 10 during polishing. In some embodiments of the present invention controller 150 is configured to analyze the electrical current and obtain the friction and/or pressure. Optionally, sensors 140 include one or more image sensors configured to capture images during polishing.

According to some example embodiments, robotic arm 110 positions and aligns object 10 in imaging station 131 prior to the polishing process to generate a 3D model of object 10. According to some example embodiments, the 3D model of object 10 is detected while object 10 is mounted on robotic arm 110. Instructions for faceting object 10 may then be defined based on the coordinate system of apparatus 100. Optionally, the instructions may be based on a target model received in association with the object, based on general guidelines related to a desired size and shape for faceting, and/or may be self-generated at imaging station 131. During the polishing process, robotic arm 110 is optionally and preferably configured to repeatedly toggle object 10 between polishing station 121 for polishing and imaging station 131 for inspection. Optionally, the 3D model defined may be updated per inspection or per a plurality of inspections. Optionally and preferably, each facet is formed over a plurality of polishing iterations and robotic arm 110 is configured to direct object 10 to imaging station 131 per iteration. According to some example embodiments, robotic arm 110 is also configured to direct object 10 to imaging station 131 at the end of the polishing process for grading object 10 and optionally for generating a signature key for object 10 based on image data obtained after the last polishing iteration.

FIG. 2 is a simplified schematic drawing of an example imaging system for the automated polishing apparatus, in accordance with some example embodiments. An imaging system 130 may be stationed in inspection station 131. According to some example embodiments, imaging system 130 includes both a microscope imaging system 257 for high resolution imaging, and a telecentric imaging system 256 for capturing 2D images of object 10 at a lower resolution as compared to the microscope imaging system 257. The imagers of microscope imaging system 257 and telecentric imaging system 256 are shown at 250 and 255, respectively. The illumination sources for microscope imaging system 257 and telecentric imaging system 256 are shown at 245 and 240, respectively. In some example embodiments, illumination source 240 for telecentric imaging system 256 is coaxial Köhler illumination.

In some example embodiments, the microscope imaging system 257 is configured to support a range of magnifications from 1× to 20×, typically with multiple lenses. In some example embodiments, microscope imaging system 257 is an inverted microscope with objects under observation positioned above, rather than below, a microscope objective lens. In some example embodiments, the spatial resolution provided by microscope imaging system 257 is higher than the spatial resolution provided by telecentric imaging system 256. For example, the field-of-view area corresponding to a single pixel size of telecentric imaging system 256 can be 10-20 times larger, e.g. 16 times larger, than the field-of-view area corresponding to a single pixel size of microscope imaging system 257.

According to some example embodiments, telecentric imaging system 256 is configured for generating a preliminary, e.g., coarse, 3D model of object 10 based on shadow modeling. According to some example embodiments, robotic arm 110 is configured to rotate and move object 10 with respect to telecentric imaging system 256 to capture silhouette images of object 10 at different orientations. The silhouettes may then be used to construct the 3D model. In some example embodiments, the coarse 3D model generated with telecentric imaging system 256 is then refined based on selected images captured with microscope imaging system 257.

According to some example embodiments, output from imaging system 256 microscope imaging system 257 is processed in processor 170. Processor 170 may be integrated into computing device 151 and/or may be a dedicated electronic circuit configured for image processing. According to some example embodiments, controller 150 manipulates 3D positioning of object 10 with respect to telecentric imaging system 256 and microscope imaging system 257. Optionally, processor 170 is also configured to process output from imaging system 257 to detect geometry and morphology of facet 15. Optionally, processor 170 is configured detect and segment artifacts on facet 15.

Modeling Object with Automated Faceting Apparatus

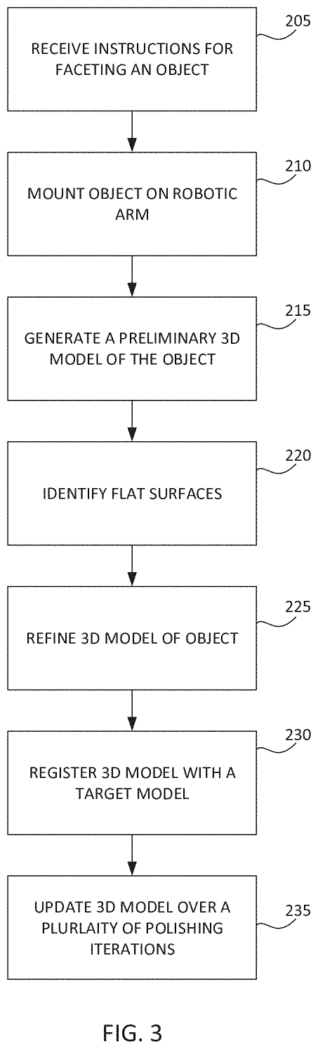

FIG. 3 is a simplified flow chart of an example method to generate a 3D model of an object for faceting, in accordance with some example embodiments. Typically, an object is received together with instructions for faceting (block 205). Instructions may include a 3D model of the object in its current configuration, e.g. rough object prior to faceting and a 3D model of target object. When a 3D model is available, the generated 3D model may be registered with the given 3D model so that the faceting instructions as indicated in the given 3D model may be related to the generated 3D model. Alternatively, the instructions may include proportions of target polish as an input, a required cut and/or symmetry grade and the target object may be generated by apparatus 100, e.g. at imaging station 131. For example, based on inspection at imaging station 131, a target object that provides highest yield of weight within the given proportions may be defined by apparatus 100. In order to translate the instructions received to instructions that may be performed with apparatus 100, a 3D model of the object is generated with apparatus 100. According to some example embodiments, prior to generating a 3D model with apparatus 100, the object is mounted on robotic arm (block 210). Since the object is mounted on the robotic arm, the 3D modeling is performed on the portion of the object that is exposed. For example, the object may first be mounted into pavilion press-pot where the designated crown is inside the press-pot and the designated pavilion is exposed.

According to some example embodiments, a preliminary 3D model of object 10 as positioned on press-pot and robotic arm is generated (block 215). Optionally, the preliminary 3D model is a coarse model. In some example embodiments, shadow modeling is used to generate the preliminary 3D model. For shadow modeling collimated backlight illumination, e.g. Köhler illumination may be used to capture a number of images from known rotation angles and a 3D model may be built based on back projections. Optionally, an imaging system other than the microscope imaging system, e.g., imaging system 256, may be used for building the preliminary 3D model. According to some example embodiments, flat surfaces on the object are identified based on the preliminary model (block 220) and used for refining the 3D model (block 225).

In some example embodiments, the preliminary 3D model is refined by capturing images of flat surfaces on the object with a microscope of the imaging system. Geometry of the flat surfaces may be determined and used to refine the preliminary 3D model to obtain a more accurate 3D model. According to some example embodiments, the 3D model is also further refined over the polishing process as required. According to some example embodiments, if a target model is available, registration is performed between the 3D model as refined and the target model received (block 230). According to some example embodiments, the generated 3D model is updated during the automated faceting process based on the object being directed to the inspection station between polishing iterations (block 235).

According to some example embodiments, after polishing the portion of the object that is exposed based on the 3D model generated, the object may be mounted on the robotic arm in an alternate orientation to facet a portion of the object that was not exposed through the press-pot. With this arrangement, blocks 210-230 may be repeated to generate a 3D model of the portion of the object that was not initially exposed by the press-pot. For example when faceting the object with a crown and pavilion, the object may first be mounted with the designated pavilion part being exposed and after modeling and polishing, the object may then be mounted on the press-pot with the designated crown part exposed and the polished pavilion partially inside the press-pot. According to some example embodiments, once one side (e.g. the pavilion) has been faceted and the other side (e.g. the crown) has been mounted, the 3D model of the first side may be registered with the 3D model obtained for the second portion. Optionally and preferably, the partially exposed faceted portion of the object, e.g. partially exposed pavilion are used as flat surfaces for registering the pavilion with the crown portion based on which a complete 3D model of the polished object may be obtained.

### Generating Ordered Faceting List

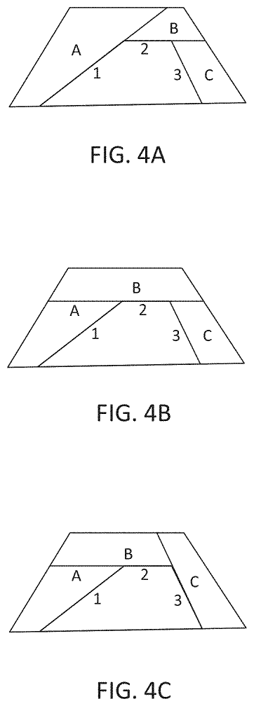

FIGS. 4A, 4B and 4C are simplified drawings depicting three example sets of instructions for forming a same plurality of facets on an object, all in accordance with some example embodiments. The present inventors have found that the polishing process may be further optimized based on selecting an order for faceting the facets. Optionally, the order may be selected to reduce the time it takes to facet the object, improve the accuracy of the faceting and/or the quality achieved. For example, FIG. 4A-4C depict three different ordered lists for polishing facets 1, 2 and 3. The faceting polishing order shown in FIG. 4A is 1, 2, 3. Based on FIG. 4A, portion A removed to form facet 1 is significantly larger than portions B and C required to be removed for subsequently forming facets 2 and 3. The faceting polishing order shown in FIG. 4B is 2, 1, 3. Based on this order, a size of section B is increased at the expense of a size of section A when comparing to FIG. 4A. The faceting polishing order shown in FIG. 4C is 3, 2, 1. Based on this selected order, a size of section C is increased at the expense of section B. In this configuration, section A, B and C are similar in size. According to some example embodiments, one or more parameters may be considered when defining an order for faceting. Example parameters without limitation include polishing angle, the amount of material to remove, size of the facet, location of the facets, artifacts on the object, e.g. internal and external. For example, polishing may be easier and faster in some polishing angles and harder and slower in others due to the crystallographic orientation of the object. In some example embodiments, the order for faceting is defined to reduce the time it takes to facet the object. Alternatively and additionally, the order for faceting may be defined to increase the accuracy of the faceting and/or the quality of the final product.

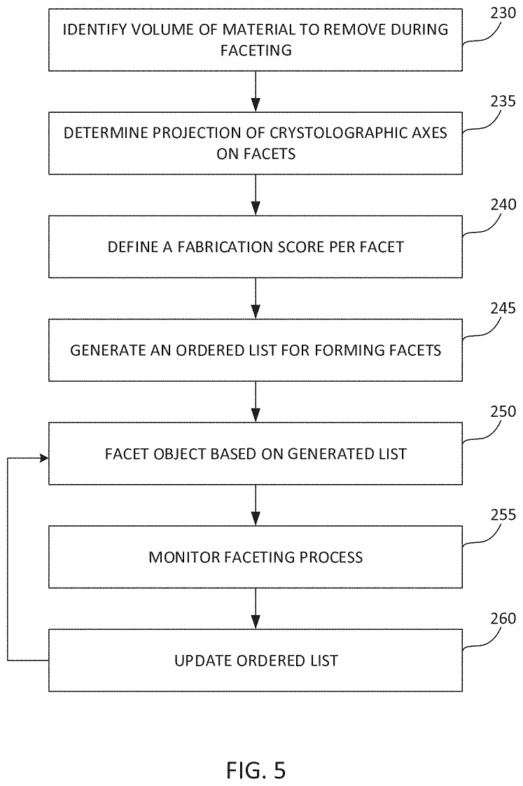

FIG. 5 is a simplified flow chart of an example method to generate an ordered list for forming facets on an object whose chemical structure is a crystal lattice, in accordance with some example embodiments. According to some example embodiments, volume of material to be removed during faceting is determined based on the 3D model of the object and a target model (block 230). According to some example embodiments, prior to generating an ordered list preliminary processing is performed on the object to predict and/or determine its crystallographic axes. In some example embodiments, projections of crystallographic axes on facets are determined based on the preliminary processing (block 235). According to some example embodiments, a fabrication score per facet may be defined to achieve a desired outcome, e.g. fast processing (block 240). The score may be based on information known, e.g. volume of material to be removed around each of the facets, orientation of the facet in relation to the crystallographic axes, and detected artifacts in the object. An ordered list for forming facets may be generated based on the scores provided (block 245). Faceting may be performed by apparatus 100 based on generated list (block 250). Optionally and preferably the faceting process is monitored (block 255), e.g. on-the-fly monitoring and based on imaging between faceting iterations and the ordered list may be updated based on accumulated data from the monitoring (block 260).

### Automated Detection of Effective Polishing Directions

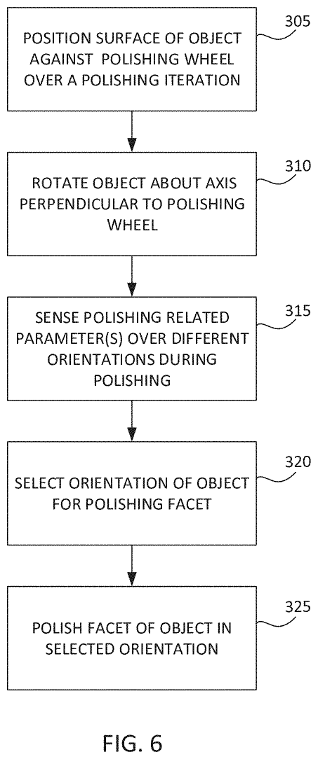

FIG. 6 is a simplified flow chart of an example method to select an orientation of a facet on a polishing wheel during polishing, in accordance with some example embodiments. According to some example embodiments, a surface of the object is positioned against polishing wheel over a polishing iteration (block 305) with a robotic arm and the robotic arm is configured to rotate the object about axis perpendicular to the polishing wheel while the facet is in contact with the polishing wheel (block 310). According to some example embodiments, one or more polishing related parameters are sensed as the object is being rotated (block 315). According to some example embodiments, an orientation for polishing may be selected based on outputs from the one or more polishing related parameters (block 320) and the facet may be polished in the selected orientation (block 325). In some example embodiments, a training or learning process may be applied during which sensed signals during successful polishing and as well as unsuccessful polishing are recorded and used as reference. Example polishing related parameters may include acceleration, vibration sensed based on contactless measurements, sound, heat, height displacement, current supplied to a motor of the polishing wheel or actuator of the robotic arm and imaging.

In some example embodiments, an accelerometer is mounted on the press-pot to detect vibrations on the object. Optionally, when the object is oriented in direction that is resistant to polishing, the object may bounce off the polishing wheel at a first range of frequencies and when the object is oriented in a direction that is conducive to polishing, frequency of vibrations may span over a second range of frequencies. Optionally, vibration amplitude may lower when the object is oriented in direction that is conducive to polishing. In another example, a rise in temperature of a polishing surface may indicate an orientation that is favorable for polishing. The inventors have found that significantly more heat is released from successfully breaking chemical bonds during polishing as compared to heat due to friction without succeeding in breaking the chemical bonds. Optionally, a rise in temperature may be sensed with an infrared (IR) camera, using IR absorption of laser (black body).

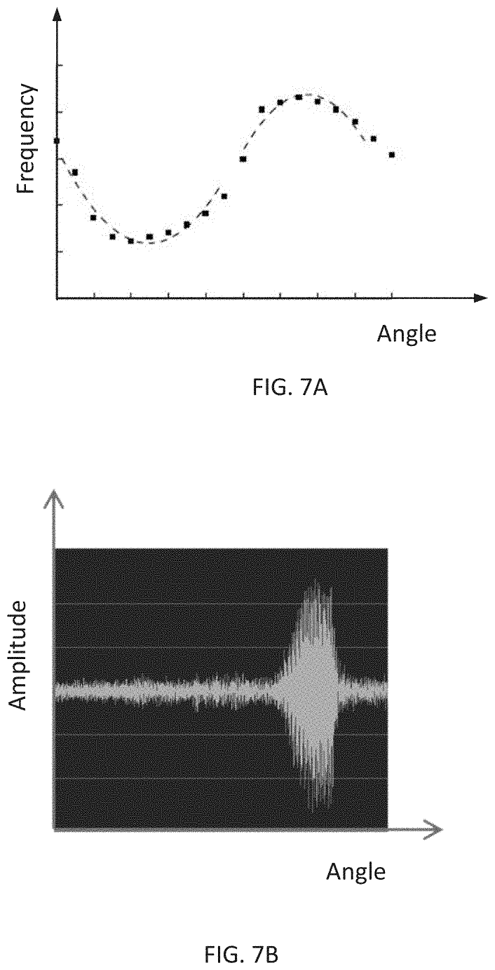

FIGS. 7A and 7B are example graphs showing output from sensors sensing a polishing related parameter while an object is rotated about an axis perpendicular to a polishing wheel during polishing, in accordance with some example embodiments. In some example embodiments, a vibration sensor may sense a frequency of vibration due to contact between the object and the polishing wheel over different polishing orientations as shown in FIG. 7A. Optionally, the frequency may be used to select a desired polishing orientation. In some example embodiments, the desired polishing orientation is an orientation that provides polishing with an improved material removal rate. In some example embodiments, sound over different polishing orientations as depicted for example in FIG. 7B may be used to detect orientations with relatively less resistance to polishing and/or faster polishing rate. For example, a frequency and/or amplitude may change when the object is at an orientation that is conducive to polishing. For example, when successfully polishing, some sound frequency components may increase their amplitude due to the removal of material.

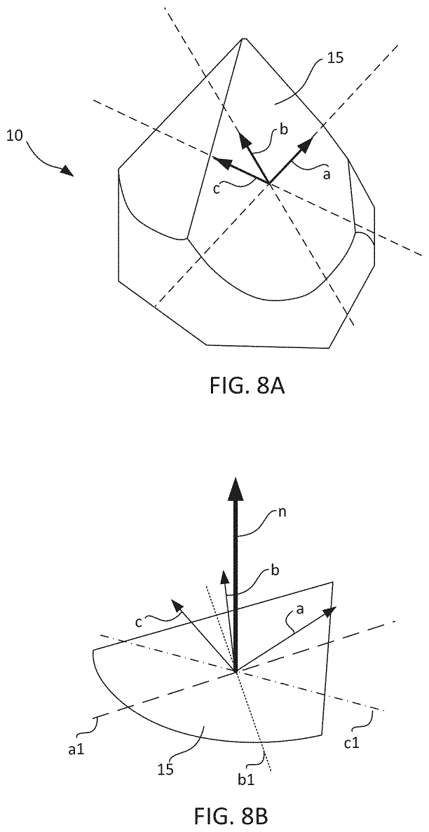

FIGS. 8A and 8B are simplified drawings showing example crystallographic axes in relation to a facet of an object in accordance with some example embodiments. When polishing a material whose chemical structure is a crystal lattice, e.g. a diamond by pressing a facet against a polishing wheel, the facet's orientation with respect to the wheel's direction of rotation affects the ability to polish the facet. Due to the crystal structure, the facet may be more easily polished in directions that correspond to orthogonal projections of the crystallographic axes on the facet and less easily polished in other orientations. FIG. 8A depicts an example object 10 that has a crystallic structure and its crystallographic axes represented by vectors a, b, and c. The easy or effective polishing directions for each facet is the direction that corresponds to orthogonal projections of a, b, and/or c. As an example, projections on a facet 15 are a1, b1 and c1 are shown in FIG. 8B. Traditionally, a manual trial and error technique is used to detect easy polishing directions for each facet by first attempting different orientations until a suitable orientation is found and then polishing in that orientation. This trial and error technique can be time consuming. Instead, the present inventors have found that based on detecting a plurality of candidate projections on one or more facets, the crystallographic axes for the object may be predicted. Once the crystallographic axes are predicted, polishing directions may be selected for other facets of the object without trial and error. The present inventors have also found that the crystallographic axes may be predicted based on detecting at least four candidate projections of the crystallographic axes. Optionally, the four candidate projections may be detected on a single facet or on 1-3 facets. Optionally, the prediction may be corrected or refined over the course of polishing additional facets.

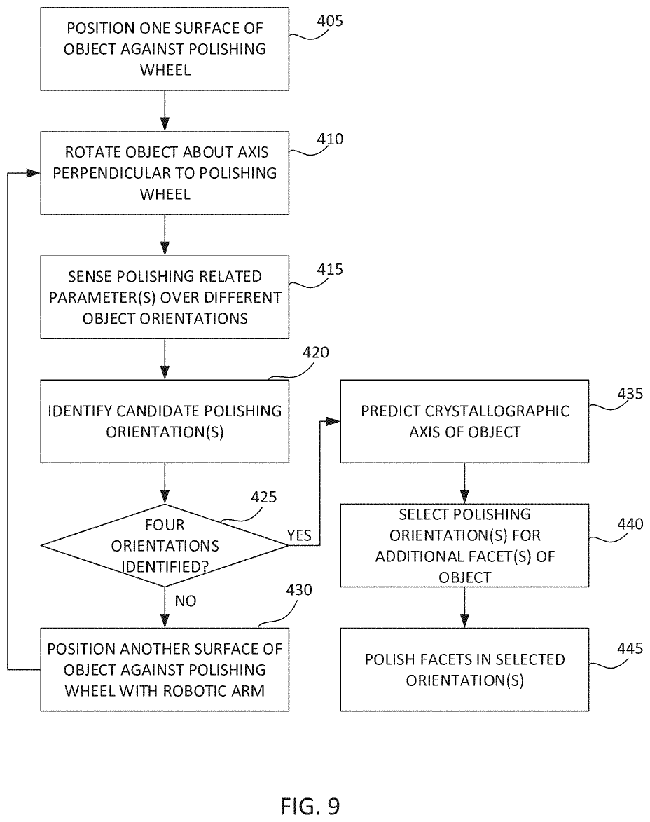

FIG. 9 is a simplified flow chart of an example method to predict crystallographic axes of the object in accordance with some example embodiments. According to some example embodiments, an initial trial-and-error process is employed for attempting to polish multiple directions on a facet, and an easy direction may be determined as the direction that is polished at the greatest removal rate during a given interval of time. The trial-and-error process begins by placing one surface of object against a polishing wheel (block 405) and rotating the object about an axis perpendicular to said polishing wheel (block 410). One or more polishing related parameter(s) are sensed over different object orientations with surface on polishing wheel (block 415). Representative examples of polishing related parameters suitable for the present embodiments include, without limitation, acceleration, vibration sensed based on contactless measurements, sound, heat, height displacement, pressure, current supplied to a motor of the polishing wheel or actuator of the robotic arm and imaging. In some example embodiments, the robotic arm is configured to rotate the object with 360° and/or +/−180° so that all orientations may be sensed. Other ranges are also contemplated, e.g., 180°, 270° or 90°. Optionally, the object is rotated in a continuous motion, e.g. at an angular speed of 0.5-2 rad/s. In some example embodiments, the rotation may be performed in discrete steps and one or more polishing parameters may be sensed per discrete steps.

In some embodiments, a removal rate is determined based on one or more of the polishing related parameters sensed. The removal rate may be defined based on volume (for example, μm³/h) or weight (for example, mg/h). In some example embodiments, the removal rate may be determined based on parameters detected on-the-fly, e.g. based on sound frequencies and displacement progress signals to detect polishing directions. Optionally, the volume is determined based on imaging the facet. Optionally, the imaging is performed at the imaging station between trial polishing intervals at defined orientations. For example, the volume removed may be determined by a 3D to 2D match, or registration, between an image of the current facet and the previously determined 3D model, as described above. Inspection may be repeated for a plurality of orientations. The inspection may be used in addition to the on-the-fly detection and removal rate may be determined based on imaging as well as based on the on-the-fly detection. Optionally, the imaging is applied as a subsequent step to refine the detection of candidate polishing directions. According to some example embodiments, one or more candidate polishing orientations may be sensed for each facet tested (block 420). Optionally, a primary as well as one or more secondary candidate polishing orientations may be detected. The present inventors have found that 1-4 candidate polishing orientations may be detected per facet. According to some example embodiments, when at least four candidate polishing orientations are detected, prediction may be initiated (block 425, “YES”), and when less than four candidate polishing orientations are detected (block 425, “NO”) one or more additional facets may be tested to detect for candidate polishing orientations until at least four orientations have been found (block 430).

Once at least four orientations have been detected (block 425, “YES”), the detected orientations may be used to predict the crystallographic axes of the object (block 435). Optionally, additional facets may be tested to improve the prediction. The predicted crystallographic axes may be stored and used to select polishing orientations for polishing other facets of the object without performing the trial and error routine for the facet (block 440). Each of the other facets may then be polished in their selected orientations (block 445). According to some example embodiments, orthogonal projections of the predicted crystallographic axes may be computed for each of the other facets and a polishing orientation may be selected to correspond to one of the orthogonal projections. Optionally, polishing orientation selected for a facet may be a polishing orientation corresponding to the largest orthogonal projection of a crystallographic axis on this facet. Other considerations may be applied in selection, e.g. morphology of the facet. The present inventors have found that the prediction method as described herein reduces the time needed to complete the faceting and also avoids potential damage to the object.

According to some example embodiments, the prediction considers the object as formed from a single crystal and therefore as having a common crystallographic set of axes and that easy and/or effective polishing directions are the orthogonal projections of the crystallographic axes on a facet. In some embodiments of the present invention the crystallographic axes are extrapolated from easy and/or effective polishing directions that have been identified during the trial and error process performed on 1-3 facets, based on a 3D model of the object constructed as further detailed hereinabove. Optionally, each of the candidate polishing directions detected on a facet may be defined by a pair of Cartesian coordinates at an arbitrary point on the facet. Each pair of Cartesian coordinates define a vector in a candidate polishing directions. According to some example embodiments, a plurality of possible orientations of the crystallographic axes may be inferred based on the extrapolations performed. In some example embodiments, the prediction may be improved based on computing an angular deviation between the estimated normal projection determined from an initial extrapolation of the predicted crystallographic axes and the actual polishing direction as determined from the detected removal rate during the trial and error procedure. Optionally, a sum of squared angular deviations related to the different polished facets of the first set are computed and used to refine the prediction. Optionally, if no convergence is detected an additional trial and error procedure may be initiated to obtain more data for improving the prediction.

### On-the-Fly Adaption of Polishing Parameters

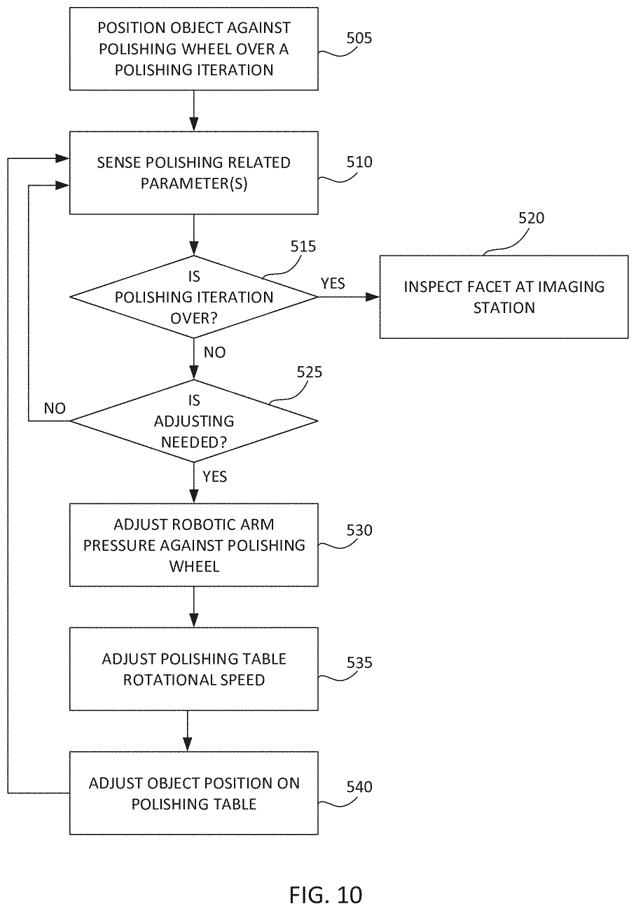

FIG. 10 is a simplified flow chart of an example method to adjust a polishing on-the-fly with the automated polishing apparatus, in accordance with some example embodiments. According to some example embodiments, each facet may be polished over one or a plurality of polishing iterations. After a polishing iteration, the object may be inspected in the imaging station. The 3D model may be updated based on the inspection and polishing instructions may be updated. A polishing iteration may be defined based on a selected parameter sensed during polishing and/or based on estimated material removed. Optionally, duration of each iteration is 1 second to 1 minute, e.g. a few seconds.

A polishing iteration begins with the object being positioned against polishing wheel (block 505). During polishing, one or more polishing related parameters are sensed, e.g. monitored and used to monitor the estimated material removed on-the-fly. Example polishing related parameters include vibration, temperature, height along the Z axis of the robotic arm, electrical current supplied to the robotic arm to press the object against the polishing wheel, current supplied to the polishing wheel. According to some example embodiments, based on the one or more polishing related parameters and/or estimated material removed the iteration is terminated (block 515, “YES”). Optionally, an average area of the facet is estimated based on the sensing and/or based on the estimated material removed and modeled 3D geometry. Optionally, the iteration continues until a defined amount of material is estimated to have been removed and/or a defined facet size or shape has been reached, both as long as temperature is below a defined threshold and/or as long as a defined iteration duration has not been exceeded. At the end of the polishing iteration, the object is moved to the imaging station with the robotic arm for inspection (block 520).

According to some example embodiments, the one or more polishing related parameters sensed during the iteration are also used to adjust polishing parameters on-the-fly (block 525). Optionally adjustments include one or more of adjusting pressure at which the robotic arm presses the object against the polishing wheel (block 530). Alternatively or additionally, adjustments include adjusting the rate at which the polishing wheel is rotating (block 535). Alternatively or additionally, adjustments include changing the track used for polishing by shifting the object along a diameter of the polishing wheel (block 540). Additional parameters that may be controlled on-the-fly include polishing direction, polishing track diameter, polishing track roughness, and duration of the polishing interval. The adjustments may be based on for example sensed temperature, polishing rate, vibration, static and dynamic friction and warping of the apparatus. The parameters and their thresholds are optionally and preferably selected to improve the smoothness, and/or accuracy of the polishing, and to reduce damage to the object during polishing.

When the stopping criterion of the iteration relates to the amount of material estimated to have been removed, the amount of material removed can be estimated as the change r in the height h of the object per unit time t (r=h/t) for a given surface area of the facet. The relation between r, the pressure P applied by the object to the wheel, and the linear velocity of the wheel is given by r=KPv, where K is a Preston coefficient. The Preston coefficient may be determined empirically for a particular apparatus. The adaptation according to these is selected to maintain a generally constant value for r. This can be done by selecting the force applied by the object on the wheel, based on a predetermined value of r, the rotational velocity of the wheel, and an estimated area A of the facet being polished. According to some example embodiments, A is estimated on-the-fly based on the detected change in height h and a previously computed area of the facet based on imaging. Specifically, the force F applied by the object can be calculated as F=r/(KAv). The area may also computed between polishing iterations for example, by imaging the facet intermittently with the polishing.

It is appreciated that the force applied by the object depends linearly on the electrical current used to control the robotic arm. Thus, according to some embodiments of the present invention the current is varied based on the value of the area A so as to maintain a generally constant value of r. This can be done without selecting the force directly. For example, a look up table can be prepared in advance, which look up table can include entries which relate the current to the force and the area. In these embodiments, the method calculates the ratio r/(Kv), and defines a query force by multiplying this ratio by A/A_{LT}, where A is the measured or estimated area of the facet and A_{LT} is an area entry of the lookup table. The method can then search the look up table for a look up table force value that matches the query force, extract the corresponding electric current from the look up table, and applies the extracted current to control the force of robotic from on the object. When no exact match for the query force is found, the method can use interpolation to extract an interpolated value for the electric current.

A correlation between the one or more polishing parameters and the Force (F) may be determined by a learning phase that may involve generating reference information by measuring large number of facets while they are being polished and recording the frequencies and/or motor current while comparing it to the actual removal rate of material. According to some example embodiments, operation of the robotic arm and/or the polishing wheel may be adjusted to maintain rate of material removal r substantially constant.

### Iterative Adaption of Polishing Parameters

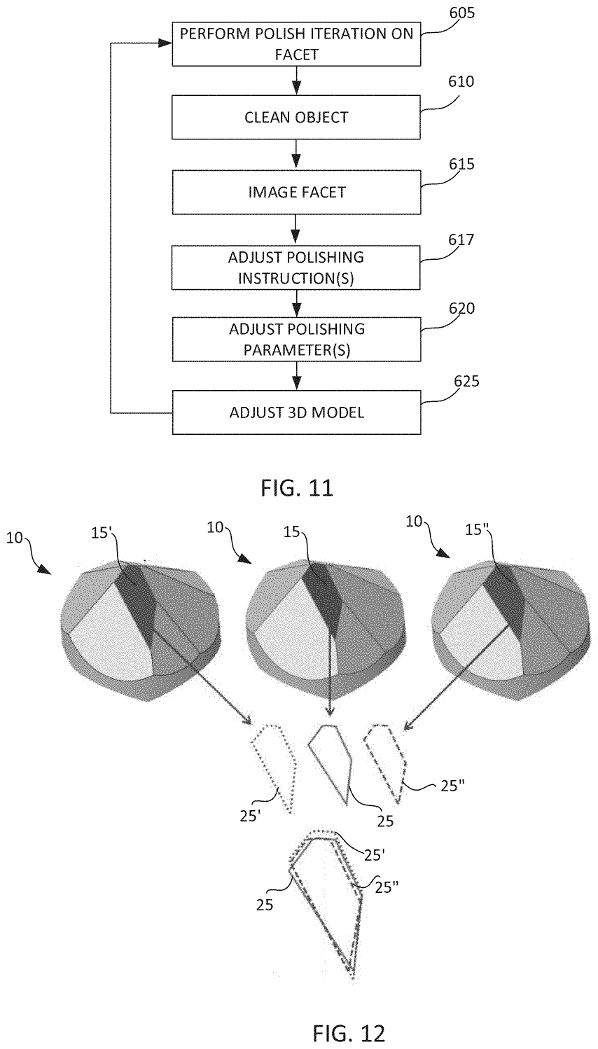

FIG. 11 is a simplified flow chart of an example method to adjust the polishing based on image data captured with the automated polishing apparatus, in accordance with some example embodiments. According to some example embodiments, each facet may be formed over 1-20 polishing iterations. Between iterations, the object may be inspected, the 3D model of the object may be updated, and adjustments to the faceting process may be defined based on the inspection. According to some example embodiments, an iteration cycle may include polish the facet over a defined iteration (block 605). The iteration may be defined based on a duration, a change in detected height as well as other polishing related parameters as described herein. At the end of an iteration, the facet may be cleaned (block 610). Optionally and preferably, steam is sprayed on the facet to clean it. According to some example embodiments, the object is directed to the imaging station and is imaged (block 615). According to some example embodiments, morphology of the facet is detected and/or characterized based on the imaging. Optionally, artifacts on the facet's surface and/or internal artifacts may be detected based on the imaging. In some example embodiments segmentation and classification of surface artifacts are performed. Optionally, bright field and/or dark field illumination may be used for the segmentation and classification. Optionally, a polish grade is detected based on said imaging.

According to some example embodiments, instructions for polishing the object may be adjusted based on the imaging (block 617). An example adjustment may include increasing the polishing depth beyond the initial plan, when detecting an uneven finished surface. Another example adjustment may include changing polishing direction based on detecting a crack. Yet another example adjustment may be to move on to polishing a different facet and returning to the current facet at later stage, e.g. push the current facet to the end of the polishing order queue.

According to some example embodiments, one or more polishing parameters are adjusted based on the imaging (block 620). An example adjustment may include reducing pressure on the object during polishing based on detecting an artifact. Optionally, the reduced pressure may provide reducing the temperature of the object during polishing. Another example adjustment may include altering a track used for polishing based on detecting scratches. Scratches may indicate that a polishing track has been used up and requires replacement. An alternate track may selected until the track is replaced. According to some example embodiments, the 3D model is adjusted to reflect the new structure of the object (block 625) based on the polishing iteration. Optionally, adjustments may be made to subsequent polishing iterations based on the updated 3D model.

FIG. 12 is a simplified schematic drawing of a modeled geometry for an example modeled facet and two example discrepancies in facet geometry that may occur during faceting in accordance with some example embodiments. Facet 15 represents a facet as modelled in a 3D model of object 10. A geometry of facet 15 is represented by contour 25. In some example embodiments, an actual corresponding facet 15′ may have been polished too deep so that contour 25′ has a larger surface area than the 3D model contour 25. In some example embodiments, an actual corresponding facet 15″ may have been polished with error in angle (tilt) and a corresponding contour 25″ may be skewed in relation to 3D model contour 25. According to some example embodiments, these discrepancies are corrected for in the updated 3D model. In some example embodiments, these discrepancies may also be a cause to modify the subsequent polishing instructions and perhaps even the remaining facets' ordering.

### Inspection of the Object Post Faceting

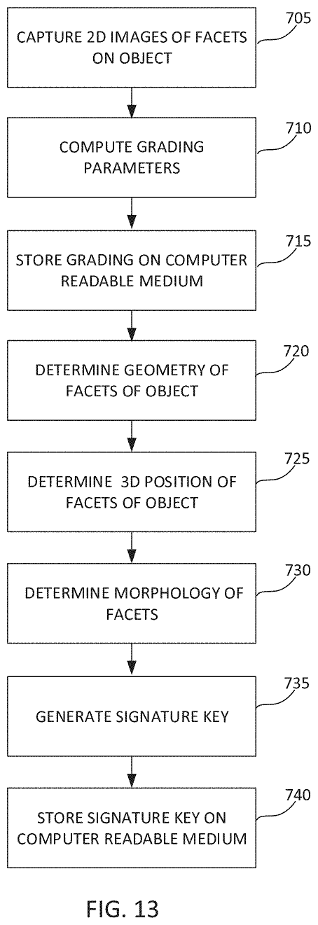

FIG. 13 is a simplified flow chart of an example method to detect and record parameters of the object at the end of the faceting process. According to some example embodiments, after an object has been faceted and before dismounting the object from the robotic arm, the robotic arm directs the object to the imaging station 131 for final inspection and characterization. According to some example embodiments, 2D images of each of the facets of the object is captured with microscope 250 in imaging system 130 (block 705). According to some example embodiments, grading parameters are determined based on the microscope images captured (block 710). Example grading parameters include, cut grade, symmetry grade and surface polish grade. The grading may be stored on computer readable medium for reference (block 715).

In some example embodiments, the 2D images are also used to generate a signature key for the object. The signature key may be generated based on characterizing features of the facets in the image data. In some example embodiments, geometry of each of the facets is determined based on the 2D images captured (block 720). In some example embodiments, 3D position of each of the facets of object is determined (block 725). 3D position may be defined based on the coordinate system of robotic arm 110 and/or based on the 3D model generated for the object. In some example embodiments, morphology of one or more facets is characterized based on the imaging (block 730). Optionally, detected artifacts may be segmented and classified and/or characterized. According to some example embodiments, a signature key is generated based on the detected geometry, positioning and morphology of the different facets (block 735). The signature key is stored on computer readable medium for reference (block 740). According to some example embodiments, blocks 705-740 may be performed once after faceting a pavilion of the object and repeated after faceting the crown of the object. Optionally, the grading may be defined after inspecting both the crown and the pavilion. Optionally, the signature key is generated after inspecting both the crown and the pavilion.

### Dual Process Faceting Apparatus

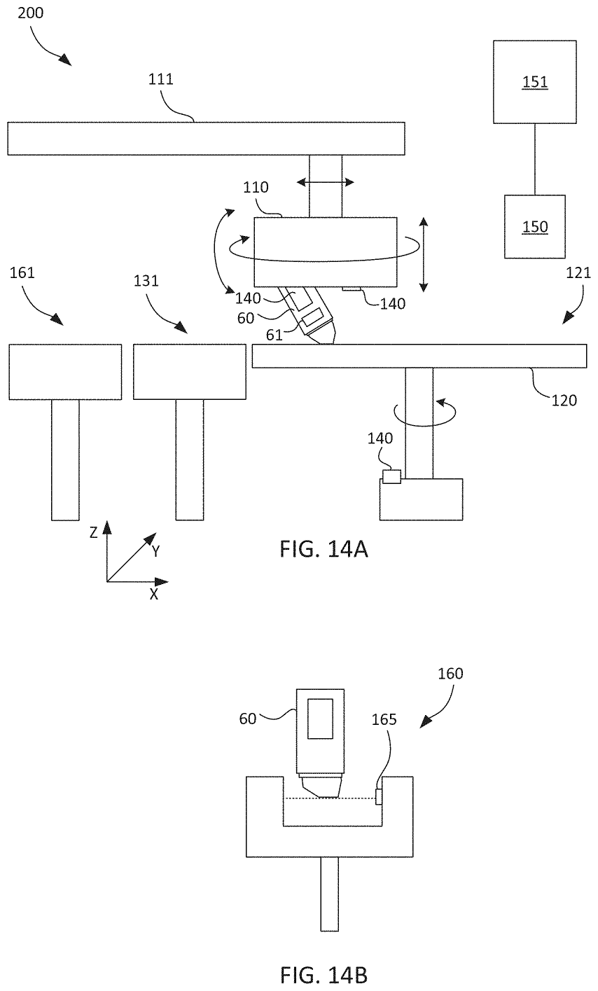

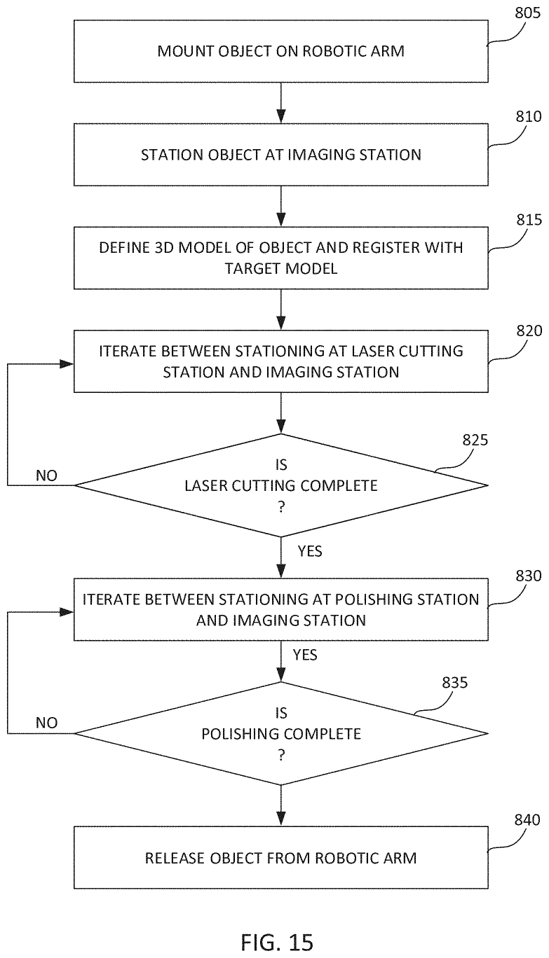

Reference is now made to FIG. 14A showing a simplified schematic drawing of an example automated faceting apparatus including both a laser cutting station and a polishing station, to FIG. 14B showing a simplified schematic drawing of a laser cutting station and to FIG. 15 showing simplified flow chart of an example method to combine laser cutting and polishing for faceting an object, all in accordance with some example embodiments.

According to some example embodiments, an automated apparatus 700 configured for faceting an object 10 includes both a laser cutting station 171 and a polishing station 131 for processing the object. In some example embodiments, laser cutting may significantly reduce the time it takes to facet object 10. In some example embodiments, the process is defined so that a first 70%-90% of the material is removed based on laser cutting at laser cutting station 171 and the remainder of the material is removed based on polishing at polishing station 121. Although polishing is generally a slower process, it is advantageous in that it typically provides more accuracy and a better finish.

According to some example embodiments, the processing starts with mounting object 10 on robotic arm 110 (block 805) and stationing robotic arm 110 at imaging station 131 (block 810). At imaging station 131, a 3D model of object is computed based on the coordinate system of apparatus 700 and the model is registered with a target model when available (block 815). A set of instructions for faceting object 10 may be defined. The instructions may include defining a first portion of the object to be removed with laser cutter 175 and a second portion of object 10 to be removed with polishing wheel 120. In some example embodiments, the first portion is defined to remove 70%-90% of material for forming each facet so that 10%-30% of the remaining material is removed by polishing. In this manner, polishing may be applied to complete each of the facets at a desired accuracy and polish finish.

According to some embodiments, over a first plurality of faceting iterations, robotic arm toggles between stationing object 10 at laser cutting station 171 for cutting with a laser beam 175 and stationing object 10 at imaging station for inspection (block 820). Optionally, one or more of the laser cutting parameters and/or the 3D model is updated over the laser cutting iterations based on the inspection in imaging station 131. Optionally, the toggling is only initiated once per facet or once per a plurality of facets. In some example embodiments, toggling is not required during laser cutting and inspection is performed at the end of the laser cutting process. In some example embodiments, laser cutter 175 is stationary and robotic arm 110 is configured to orient object 10 with respect to laser cutter 175. Optionally, the laser cutter may be configured to move in one or more directions and object 10 is held stationary in laser cutting station 171.

When the laser cutting is completed, e.g. when the first portion has been removed (block 825), robotic arm 110 begins iterating between stationing the object at polishing station 121 and imaging station 131 (block 830). One or more of the polishing parameters and/or the 3D model may also be updated over the polishing iterations based on the inspection. Once the polishing is complete (block 835) the object may be removed from robotic arm 110 (block 840). In some example embodiments, the object is mounted again on the robotic arm 110 with a different part of the object being exposed, e.g. with the designated crown portion being exposed after the pavilion portion has been faceted, and blocks 805-840 are repeated to facet the additional part of the object.

### Press-Pot Identification Code

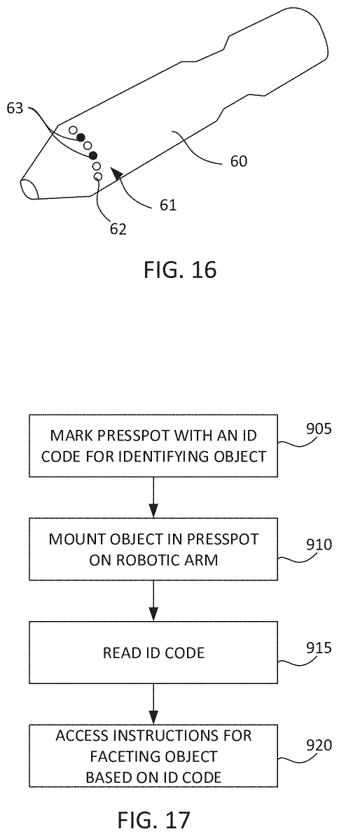

FIG. 16 is an example press-pot for holding an object in accordance with some example embodiments. According to some example embodiments, an ID code 65 that is configured to identify an object may be positioned on press-pot 60 that is holding the object. According to some example embodiments, press-pot 60 is formed with a plurality of blind holes 62 that are configured to receive plugs 63. Optionally a pattern of plugged and unplugged blind holes 62 defines the ID code. In some example embodiments, imaging system 130 is configured to identify the ID code based on imaging. Other methods of adding an ID code are contemplated. For example a barcode may be attached to press-pot 60. Optionally, and RF ID tag may be attached to press-pot 60 and the ID code may be read with a dedicated reader.

FIG. 17 is a simplified flow chart of an example method to identify object with press-pot identification code, in accordance with some example embodiments. According to some example embodiments, a press-pot is marked with an ID code for identifying an object (block 905) and the object with the press-pot is mounted on the robotic arm (block 910). According to some example embodiments, the ID code is read in the imaging station (block 915) and the instructions for faceting an object are accessed based on the reading (block 920). Optionally, an operator may receive a plurality of objects for faceting at any one time. Optionally, each of the objects may be mounted on a press-pot and marked with an ID code. The plurality of objects may be processed one at a time and mix-ups between the objects may be avoided with the ID code.

In the apparatus and/or method disclosed herein, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

### EXAMPLE

Reference is now made to the following example method that may be used to predict crystallographic axes based on at least 4 empirically detected favorable polishing directions on a diamond. This example together with the above descriptions illustrate some embodiments of the invention in a non-limiting fashion.

The input for the method is at least four favorable polishing directions empirically detected on 1-3 facets on an object whose chemical structure is a crystal lattice, e.g. a diamond. Output of the method is the orientation of the crystallographic axis vectors, a, b and c (in the same Cartesian coordinate system) and predicted polishing direction for each facet.

The method described below is for the case in which the favorable polishing directions are the orthogonal projections of the a, b or c crystallographic axes on the facets of the crystal, and the object is in the form of a single crystal.

The method assumes that the initial orientation of the crystal is unknown, and uses all input directions relative to the current orientation of the crystal. Given the known 3D model, a geometric relationship between the input facets is known, allowing the extrapolation of the original crystallographic axes whose projections resulted in our input. Herein, Cartesian coordinates are used to describe directions of the vectors a, b and c, e.g. a=aₓ X+a_{y}Y+a_{z}, etc.

With the crystallographic axes predicted, the method may calculate favorable polishing directions for each potential face of the polyhedron for which no trial-and-error procedure has been employed (as shown in FIG. 8B). For example, three favorable polishing directions, (a₁, b₁, c₁), in the face normal to a vector n are defined by: a₁=[n×[a×n]], b₁=[n×[b×n]], c₁=[n×[c×n]]. The symbol × stands for the cross product. The calculation of vector product in Cartesian coordinate system is defined by Equation (1):

[A×B]=(A_{y}B_{z}−A_{z}B_{y})X+(A_{z}Bₓ−AₓB_{z})Y+(AₓB_{y}−A_{y}Bₓ)Z (1)

The input parameters to the method may be multiple coordinates (for example 5-20, e.g., 10 coordinates) for each facet. These are Cartesian coordinates of three arbitrary points (e.g. the coordinates of three vertices, R₁={X₁₁, X₁₂, X₁₃}, R₂={X₂₁, X₂₂, X₂₃}, R₃={X₃₁, X₃₂, X₃₃}) and the direction of easy polishing (the angle between the easy polishing direction and R₂−R₁ direction). Any other format of the input data may be used as needed.

The output parameters to the method are preferably the orientation of the vectors, a, b and c (for example, in the same Cartesian coordinate system) and predicted polishing direction for each facet.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1-50. (canceled)

51. A method for automated faceting of an object, the method comprising:
polishing the object with a polishing wheel concurrently with:
sensing at least one polishing related parameter; and
in a closed loop control, adjusting at least one operation parameter selected from the group consisting of: rotation speed of said polishing wheel, contact pressure of object against polishing wheel and track position of the object on the rotating wheel, responsively to a value of said sensed polishing related parameter.

52. The method of claim 51, wherein said adjusting is selected to control a material removal rate for removing material from the object.

53. The method of claim 51, comprising terminating said polishing when a value of said parameter is within a predetermined range.

54. The method of claim 51, comprising:
obtaining a three-dimensional model of the object and a target three-dimensional shape having a plurality of facets;
for each of a plurality of facets of said target shape, calculating based on said model an amount of material to be removed from the object to form said facet; and
generating an ordered list of said plurality of facets in a manner that said calculated amounts are descending within said list; and
wherein said polishing comprises executing a protocol for polishing the plurality of facets of the object according to said ordered list.

55. The method of claim 54, comprising imaging the object intermittently with said forming to determine geometry and morphology of a facet being formed, and updating said ordered list based on said imaging.

56. The method of claim 54, comprising:
imaging the object intermittently with said forming to detect morphology; and updating instructions for polishing subsequent polishing iterations based on said detected morphology.

57. The method of claim 56, wherein detecting morphology includes segmentation and classification of artifacts in or at a surface of a facet.

58. The method of claim 56, wherein updating instructions is selected from the group consisting of increasing the polishing depth beyond an initial plan, changing polishing direction, changing polishing pressure, changing polishing wheel velocity, changing linear movement on the wheel, changing polishing interval, altering a track of a polishing wheel used for polishing and progressing to polishing a different facet before completing polishing of a current facet.

59. The method of claim 51, comprising:
obtaining a three-dimensional model of the object, and a target three-dimensional shape defining the multiple facets;
for each of a plurality of facets of said target shape, calculating based on said model a projection of a crystallographic axis of the object onto said facet, an amount of material to be removed from the object to form said facet, and a fabrication score which is a weighted combination of said projection and said amount; and
generating an ordered list of said plurality of facets in a manner that said calculated scores are descending within said list;
wherein said polishing comprises executing a protocol for forming said plurality of facets according to said ordered list.

60. The method of claim 59, comprising:
forming at least two facets of the object with an automated polishing apparatus;
sensing a polishing related parameter during said forming; and
predicting crystallographic axes of the object based on said sensing;
wherein said generating said ordered list of said plurality of facets is also based on said prediction.

61. The method of claim 51, wherein there are at least two polishing related parameters, and wherein one of said at least two polishing related parameters is a vertical position of the object.

62. The method of claim 51, wherein said at least one polishing related parameter is selected from the group consisting of: vibration, sound, displacement, dissipated heat and pressure applied on the object, associated with contact of the object with said polishing wheel during polishing.

63. The method of claim 51, wherein said at least one polishing related parameter is electrical current supplied to a robotic arm, said electrical current related to pressure of object against polishing wheel.

64. Apparatus for automated faceting of an object comprising:
a polishing wheel;
a robotic arm configured to position the object in contact with said polishing wheel;
a sensor configured to sense at least one polishing related parameter during polishing of the object by said polishing wheel; and
a controller configured to adjust at least one operation parameter selected from the group consisting of current to said robotic arm, a rotation speed of said polishing wheel, and track used on said polishing wheel, during said polishing and in a closed loop control, responsively to a value of said sensed polishing related parameter.

65. The apparatus of claim 64, comprising an imaging system, wherein said controller is configured to operate said robotic arm to maneuver the object to a focal plane of said imaging system, to operate said imaging system to image a facet of the object intermittently with said polishing, to determine geometry and morphology of said facet, and to update instructions for polishing subsequent polishing iterations based on said detected morphology.

66. An apparatus for automated faceting of an object, comprising:
a polishing wheel;
a robotic arm configured to position the object in contact with said polishing wheel;
a sensor configured to sense a polishing related parameter during polishing of the object by said polishing wheel; and
a controller configured to:
operate said robotic arm to rotate the object about an axis perpendicular to said polishing wheel;
receive a sensing signal from said sensor at different orientations of said object during polishing; and
select a polishing orientation from said different orientations based on said sensing signal.

67. The apparatus of claim 66, wherein said controller is configured to rotate the object while maintaining contact between the object and the polishing wheel and to continuously receive said sensing signal during said rotation.

68. The apparatus of claim 66, wherein said sensor is configured to sense an amplitude or frequency of vibration associated with said contact of the object with said polishing wheel during polishing and wherein said polishing orientation selected is an orientation at which said amplitude or frequency of vibration exhibits a predefined recognizable feature.

69. The apparatus of claim 66, comprising at least one additional sensor configured to sense an additional polishing related parameter during polishing and wherein said controller is configured to select said polishing orientation based on said sensing signal from said sensor and an additional sensing signal from said additional sensor.

70. The apparatus of claim 66, further comprising an imaging system, wherein said controller is configured to operate said robotic arm to maneuver the object to a focal plane of said imaging system, and to operate said imaging system to image a facet of the object intermittently with said polishing.
